(19) United States
(12) Patent Application Publication
(10) Pub. No.: US 2025/0243070 A1
(43) Pub. Date: Jul. 31, 2025

(54) METHOD FOR PRODUCING PURIFIED GRAPHITE

(71) Applicant: DORFNER ANZAPLAN GMBH, Hirschau (DE)

(72) Inventors: Thomas FELBINGER, Wenzenbach (DE); Tobias HEIBL, Amberg (DE); Daniel RISCHE, Freudenberg-Aschach (DE); Christian GRAF, Amberg (DE)

(21) Appl. No.: 18/856,064

(22) PCT Filed: Mar. 30, 2023
(86) PCT No.: PCT/EP2023/058335

§ 371 Date: Oct. 11, 2024

(30) Foreign Application Priority Data
Apr. 12, 2022 (DE) 10 2022 108 846.4

(51) Int. Cl. C01B 32/215

(52) U.S. Cl. CPC C01B 32/215

(57) ABSTRACT

A method for producing purified graphite comprising: first acid leaching of a graphite starting material with an acid at a temperature not exceeding 100° C.; first filtration to produce a first residue and a first filtrate; washing the first residue with distilled water; basic digestion of a mixture of a base and the first washed residue at a temperature in the range from 350° C. to 550° C.; leaching of the mixture with water; second filtration to produce a second residue and a second filtrate; washing the second residue with distilled water; second acidic leaching of the washed second residue with an acid at a temperature not exceeding 100° C.; third filtration to produce a third residue and a third filtrate; and washing the third residue with distilled water.

### CROSS-REFERENCE TO RELATED APPLICATION

The present application is the national phase entry of International Application No. PCT/EP2023/058335 filed 30 Mar. 2023, which claims priority to Germany Patent Application No. 10 2022 108 846.4 filed 12 Apr. 2022, the disclosures of which are incorporated by reference herein.

### FIELD OF THE DISCLOSURE

The invention relates to a method for producing purified graphite.

### BACKGROUND OF THE INVENTION

A method for producing purified graphite is already known from AU 2021261902 B2. A mixture of a graphite starting material and a 50% NaOH solution is produced. The mixture is heated to a temperature of 450° C. to 550° C. in a rotary kiln. The dry mixture is then mixed with water, filtered and washed. This results in a washed residue, which is further purified by means of several acidic and one basic leaching step.

The known procedure requires relatively many steps and is time-consuming.

CN 114 212 788 A discloses a method for producing purified graphite. In the known process, a graphite starting material is first leached with HCl. A first filtration is then carried out to produce a first residue. The first residue is washed with water. The washed first residue is then digested with a base at a temperature in the range from 400° C. to 600° C. The treated mixture is then washed and subjected to ultrasonic treatment.—The ultrasonic treatment produces an improved cleaning effect.

CN 1031 512 A relates to a method for producing purified graphite. In this process, a graphite starting material is first stirred with a 50-70% NaOH solution at a temperature in the range of 180° C. to 200° C. for 2 to 4 hours. After a filtering and washing step, the filter cake is stirred with 3-6% HCl at a temperature of 70° C. to 90° C. for 1 to 2 hours.

### SUMMARY OF THE INVENTION

The object of the invention is to overcome the disadvantages according to the prior art. In particular, an alternative method for producing purified graphite is to be disclosed, which can be carried out with reduced effort.

This problem is solved by the features of claim 1. Useful embodiments of the invention are shown by the features of the dependent claims.

In accordance with the invention, a method for the producing purified graphite comprising the following steps is proposed:
First acid leaching of a graphite starting material with an acid at a temperature not exceeding 100° C. for a specified first reaction time,
first filtration to produce a first residue and a first filtrate,
washing the first residue with distilled water,
basic digestion of a mixture of a base and the first washed residue at a temperature in the range from 350° C. to 550° C. for a predetermined second reaction time,
leaching of the mixture with water for a specified third reaction time,
second filtration to produce a second residue and a second filtrate,
washing the second residue with distilled water,
second acidic leaching of the washed second residue with an acid at a temperature not exceeding 100° C. for a predetermined fourth reaction time,
third filtration to produce a third residue and a third filtrate and
washing the third residue with distilled water.

The proposed method comprises only three steps of treatment with acids and a base. This allows an excellent cleaning performance of more than 99.95% to be achieved with reduced effort.

In the proposed method, the step of first acid leaching or leaching of a graphite starting material preferably takes place at an elevated temperature in the range of 50° C. to 100° C., in particular 60° C. to 90° C. Filtration is then carried out to produce a first residue and a first filtrate. The first residue is preferably washed several times with distilled water.

Conveniently, the step of the first and/or second acid leaching is carried out at a temperature in the range from 50° C. to 100° C. Preferably, at least one of the following acids is used: H₂ SO₄, HCl, HNO₃. The aforementioned acids or aqueous acids can be used either alone or in mixtures.

HCl or H₂ SO₄ can be used as the sole acid, particularly in the first acid leaching step. The HCl advantageously has a concentration in the range from 10% to 30%. The H₂ SO₄ advantageously has a concentration in the range from 90% to 98%. A suspension formed from the HCl or H₂ SO₄ and the graphite starting material is expediently stirred at a temperature of 70° C. to 90° C. for 0.5 to 1.5 hours. The suspension is then subjected to the first filtration to produce the first residue and the first filtrate. The first residue is expediently washed several times with distilled water.

In the second acid leaching step, H₂ SO₄, preferably in a concentration of 1.5% to 10%, particularly preferably in a concentration of 2% to 3%, can be used as the sole acid. Alternatively, the concentration of H SO₂₄ can also be 90% to 98%, preferably 96%. The first and/or third reaction time in the acid leaching steps is preferably 0.5 to 4.0 hours, particularly preferably 1.0 to 3.0 hours. In the first and/or second acid leaching step, the volume ratio of acid S to washed residue G is preferably S/G=K1, where K1 is a number in the range from 1.5 to 3.0. This means that during acid leaching, a larger volume of aqueous acid is added to the starting material or the previously produced graphite residue. The number K1 is particularly preferably in the range from 1.8 to 2.4.

The basic digestion step is advantageously carried out at a temperature in the range from 400° C. to 500° C., preferably a temperature of 420° C. to 480° C. The basic digestion is carried out at ambient pressure. After the second reaction period has elapsed, the mixture is cooled, preferably to a temperature of less than 50° C. With regard to the mixture, the following applies for a volume ratio of base B to first washed residue G: B/G=K2, where K2 is a number in the range from 0.5 to 2.0. This means that the mixture is preferably not prepared as a suspension, but as a wet powder or paste.

In the basic digestion step, NaOH or KOH is advantageously used as the base or aqueous base. The NaOH or KOH advantageously has a concentration of 35% to 50%. It has been shown that the use of NaOH in a concentration of 50% in particular produces an excellent purification performance in this step when the mixture is heated to about 450° C.

The mixture is suspended in water, preferably after cooling. The suspension is suitably stirred for the third reaction time. Leaching of the mixture with water is preferably carried out at ambient temperature.

The first and/or second and/or third and/or fourth reaction time may be 0.5 to 3.0 hours, preferably 0.5 to 2.0 hours.

In a further advantageous embodiment, at least one of the steps of washing, preferably the step of washing the first residue, is carried out at a temperature in the range from 50° C. to 85° C. The further washing steps can also be carried out at temperatures in the aforementioned range.

Expediently, at least the second and/or third and/or fourth residue is washed until a corresponding effluent filtrate has a pH of at least 4. It is expedient to wash until the pH value is at least 5.

The steps of leaching and basic digestion are expediently carried out in the sequence specified in claim 1. In addition to the specified washing and filtration steps, other steps, in particular at least one neutralization step, may also be inserted between these steps.

### BRIEF DESCRIPTION OF THE DRAWINGS

In the following, an embodiment of the invention is explained in more detail with reference to the drawings. It shows:

FIG. 1 is a first flow chart; and

FIG. 2 is a second flow chart.

### DETAILED DESCRIPTION

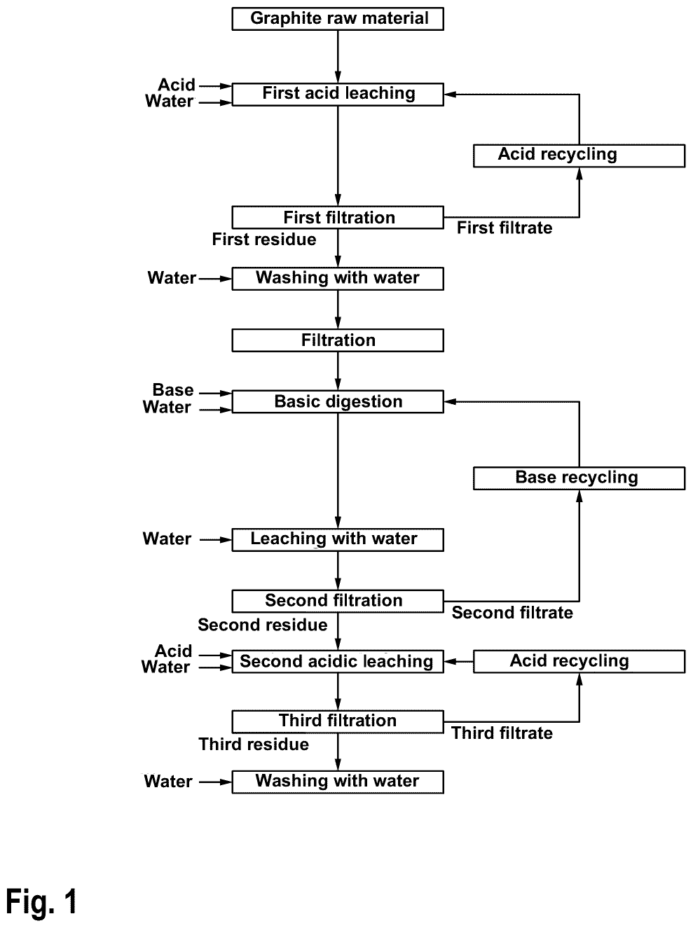

FIG. 1 shows the main steps of the method according to the invention in a first flow chart. A graphite raw material that has already been pre-purified in a conventional manner is used as the starting material. This graphite starting material usually has a graphite content in the range of 90% to 98%. The graphite starting material is essentially contaminated with minerals which may contain SiO₂, Al₂O₃ and Fe₂O₃.

The graphite starting material or the graphite to be cleaned is suspended in an acid, in particular HCl with a concentration in the range of 10% to 30%, preferably 15% to 25%. The suspension is preferably stirred at a temperature in the range of 75° C. to 85° C. for about one hour. The suspension is then filtered to produce a first residue and a first filtrate. The first residue is washed, preferably on the filter, with distilled water. Several washing steps can be carried out in succession until the filtrate leaving the filter has a pH value preferably of at least 4, in particular 5.

A mixture is then prepared from the first washed residue and 50% NaOH. The mixture is adjusted so that the solids content is more than 50% by volume. The mixture is heated, for example in a muffle furnace or rotary kiln, to a temperature of preferably 450° C. for a second reaction time of 1.0 to 1.5 hours. The basic digestion takes place at atmospheric pressure.

After the second reaction time has elapsed, the mixture is cooled. After cooling, an excess of water is added to the mixture and preferably stirred for a third reaction period of 0.5 to 1.5 hours at ambient temperature.

The leached second residue is washed with distilled water, preferably on the filter. Several washing steps can be carried out in succession. It is expedient to wash until a corresponding outflowing filtrate has a pH value of at most 10.

The second residue is then suspended in an aqueous or dilute acid, preferably in dilute H₂SO₄. To prepare the suspension, one part of the second residue is mixed with about two parts of dilute acid. The concentration of the H₂SO₄ preferably used here is 1.5% to 3.5%. The step of the second acid leaching is expediently carried out at a temperature in the range from 70° C. to 90° C. A fourth reaction time is preferably 1.5 to 2.5 hours.

This is followed by a third filtration to produce a third residue. The third residue is again washed with distilled water. The washing steps can be repeated several times until a corresponding outgoing filtrate expediently has a pH value of at least 4, preferably more than 5.

The filtrates produced during the filtration steps are usually recycled. The overall result is an energy-efficient process.

As can be seen from the following analysis results, graphite with a purity of up to 99.99% can be produced using the process according to the invention:

| | | Graphite | Purified |
|---|---|---|---|
| | | base material | graphite |
| Carbon | [% by weight] | 96.48 | 99.99 |
| SiO₂ | [mg/kg] | 13.700 | 39 |
| Al₂O₃ | [mg/kg] | 4.160 | <10 |
| Fe₂O₃ | [mg/kg] | 6.270 | <10 |

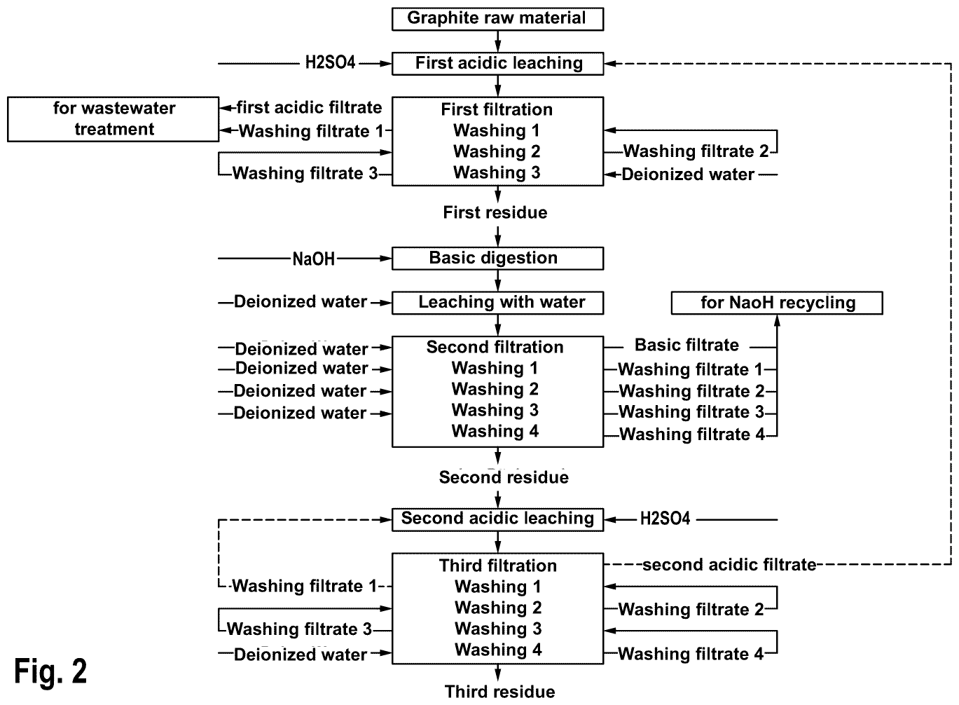

FIG. 2 shows the essential steps of another method according to the invention in a second flow chart. In this case, the graphite starting material is subjected to a first acid leaching with H₂SO₄. The treatment time is expediently 20 to 120 minutes, preferably 50 to 70 minutes, particularly preferably 60 minutes. The temperature during the first acid leaching is expediently 50° C. to 90° C., preferably 75° C. to 85° C. In the present embodiment example, concentrated H₂SO₄ is used. The concentration is advantageously 90% to 98%, in particular 95% to 96%.

After the first acid leaching step, a first filtration takes place. The residue is washed several times. This results in a first residue. A first acid filtrate and a wash filtrate are fed to a wastewater treatment plant.

The first residue is mixed with 35 to 50% NaOH, preferably 45-50% NaOH, and then digested at a temperature in the range from 300° C. to 500° C. A treatment time of 30 to 150 minutes is expedient, preferably 70 to 80 minutes.

After basic digestion, the mixture is leached in water and then subjected to a second filtration. The temperature during leaching in water is advantageously 20° C. to 90° C., preferably 50° C. A holding time during the leaching step is 30 to 90 minutes, preferably 50 to 70 minutes. A residue resulting from leaching is washed several times, so that a second residue is obtained. A basic filtrate and the wash filtrates remaining from the washing steps are sent for NaOH recycling.

The second residue is now subjected to a second acid leaching. Concentrated H₂SO₄ is again used as the acid. The concentration is advantageously 90% to 98%, in particular 95% to 97%. The temperature is set at 50° C. to 90° C., preferably 75° C. to 85° C. The holding time is expediently 60 to 240 minutes, in particular 110 to 130 minutes.

After the second acidic leaching, a third filtration takes place. Any residue produced is washed several times. A resulting second acidic filtrate and the resulting wash filtrates are expediently returned to the process and at least partially reused in the first acidic leaching step.

The third residue is a purified graphite with an excellent purity of more than 99.95%.

1. A Method for producing purified graphite comprising the following steps:
first acid leaching of a graphite starting material with an acid at a temperature not exceeding 100° C. for a first reaction time from 20 to 120 minutes;
first filtration to produce a first residue and a first filtrate;
washing the first residue with distilled water;
basic digestion of a mixture of a base and the first washed residue at a temperature in the range from 350° C. to 550° C. for a second reaction time from 30 to 150 minutes;
leaching of the mixture with water for a third reaction time from 30 to 180 minutes;
second filtration to produce a second residue and a second filtrate;
washing the second residue with distilled water;
second acid leaching of the washed second residue with an acid at a temperature not exceeding 100° C. for a fourth reaction time from 30 to 240 minutes;
third filtration to produce a third residue and a third filtrate; and
washing the third residue with distilled water,
wherein the leaching and basic digestion steps taking place in the specified order.

2. The method according to claim 1, wherein the step of the first and/or second acid leaching is carried out at a temperature in the range from 50° C. to 100° C.

3. The method according to claim 1, wherein at least one of the following acids is used in the step of the first and/or second acid leaching: H₂SO₄, HCl, HNO₃.

4. The method according to claim 3, wherein HCl or H₂SO₄ is used as a sole acid in the first acid leaching.

5. The method according to claim 4, wherein the HCl has a concentration of 10% to 30%.

6. The method according to claim 3, wherein H₂SO₄ is used as a sole acid in the second acid leaching.

7. The method according to claim 6, wherein the H₂SO₄ has a concentration of 1.5% to 10% or 90% to 98%.

8. The method according to claim 1, wherein the fourth reaction time is from 1.0 to 3.0 hours.

9. The method according to claim 1, wherein, in the step of the first and/or second acid leaching, the following applies for a volume ratio of the acid S to the washed residue G is: S/G-K1, wherein K1 is a number in a range from 1.5 to 3.0.

10. The method according to claim 1, wherein the step of the basic digestion is carried out at a temperature in the range from 400° C. to 500° C., preferably a temperature from 420° C. to 480° C.

11. The method according to claim 1, wherein for a volume ratio of the base B to the first washed residue G is: B/G=K2, wherein K2 is a number in the range from 0.5 to 2.0.

12. The method according to claim 1, wherein NaOH or KOH is used as the base in the basic digestion step.

13. The method according to claim 12, wherein the NaOH or KOH has a concentration of 35% to 50%.

14. The method according to claim 1, wherein the first and/or second and/or third and/or fourth reaction time is from 0.5 to 2.0 hours.

15. The method according to claim 1, wherein at least one of the steps of washing is carried out at a temperature in a range 50° C. to 85° C.

16. The method according to claim 1, wherein the second residue is washed until a corresponding effluent filtrate has a pH of at most 10.

17. The method according to claim 1, wherein at least the first and/or third residue is washed until a corresponding effluent filtrate has a pH of at least 5.
